(19) United States
(12) Patent Application Publication
(10) Pub. No.: US 2025/0181779 A1
(43) Pub. Date: Jun. 5, 2025

(54) MEMORY SYSTEM AND METHOD OF OPERATION THEREOF

(71) Applicant: SAMSUNG ELECTRONICS CO., LTD., Suwon-si (KR)

(72) Inventors: Yongsuk Lee, Suwon-si (KR); Sewon Kim, Suwon-si (KR); Jisoo Kim, Suwon-si (KR); Younsung Chu, Suwon-si (KR)

(21) Appl. No.: 18/923,116

(22) Filed: Oct. 22, 2024

(30) Foreign Application Priority Data
Nov. 30, 2023 (KR) 10-2023-0171827

(51) Int. Cl. G06F 21/78; G06F 21/60

(52) U.S. Cl. CPC G06F 21/78; G06F 21/602

(57) ABSTRACT

A memory system operating with encrypted user data includes a host configured to receive a user data encryption key from a server, and a memory device configured to receive the user data encryption key and meta data about the user data encryption key from the host and to encrypt or decrypt user data. The memory system receives and stores meta data associated with the user data encryption key. The memory system receives a request for the data including meta data and compares the received meta data with the stored meta data to determine if the data has been changed.

### CROSS-REFERENCE TO RELATED APPLICATION

This application is based on and claims priority under 35 U.S.C. § 119 to Korean Patent Application No. 10-2023-0171827, filed on Nov. 30, 2023, in the Korean Intellectual Property Office, the disclosure of which is incorporated by reference herein in its entirety.

### BACKGROUND

Recently, to maintain the security of user data in memory systems, a method of injecting user data encryption keys into memory devices has been utilized. In other words, the memory systems are being implemented to inject the user data encryption keys into the memory devices and perform various operations of the memory devices once the user data is encrypted. Therefore, when the user data cannot be encrypted due to errors of the user data encryption keys, the memory devices are unable to perform normal operations.

When errors have occurred in user data encryption keys, recently developed memory systems simply recognize that the errors have occurred in the user data encryption keys, but are unable to determine whether the errors have occurred in the user data encryption keys due to any cause.

### SUMMARY

To solve the above-described disadvantage, the disclosed implementation is to provide a memory system capable of, when an error has occurred in a user data encryption key, determining whether the error has occurred in the user data encryption key due to any cause.

A memory system operating with user data encrypted includes a host configured to receive a user data encryption key from a server, and a memory device configured to receive the user data encryption key and meta data about the user data encryption key from the host and encrypt user data.

A method of operating a memory system operating with user data encrypted includes receiving a user data encryption key from a server, receiving, by a memory device, the user data encryption key and meta data about the user data encryption key from a host, and encrypting user data, wherein the receiving of the user data encryption key and the meta data about the user data encryption key from the host includes storing the received meta data and when a read operation is performed, detecting whether an error has occurred in the user data encryption key by using the stored meta data, and the receiving of the user data encryption key from the server includes, when it is determined that the user data encryption key has been changed, determining the cause of change of the user data encryption key, based on a result of comparison between information on the stored meta data about the user data encryption key and received meta data about the user data encryption key.

A memory system operating with user data encrypted includes a server configured to manage a user data encryption key, a host configured to receive the user data encryption key from the server, and a memory device configured to receive the user data encryption key and meta data about the user data encryption key from the host and encrypt user data, wherein the memory device is configured to store the received meta data and when a read operation is performed, compare information on the stored meta data about the user data encryption key with received meta data about the user data encryption key and detect whether the user data encryption key has been changed, and the host is configured to, when it is determined that the user data encryption key has been changed, determine the cause of change of the user data encryption key, based on a result of comparison between the information on the stored meta data about the user data encryption key and the received meta data about the user data encryption key.

### BRIEF DESCRIPTION OF THE DRAWINGS

Implementations will be more clearly understood from the following detailed description taken in conjunction with the accompanying drawings in which:

FIG. 1 is a block diagram of an example memory system;

FIG. 2 is a block diagram of an example host;

FIG. 3 is a block diagram of an example memory device;

FIG. 4 is a flowchart illustrating an example method of operating a memory system.

FIGS. 5 and 6 are flowcharts illustrating an example process of detecting an error in a method of operating a memory system.

FIG. 7 is a flowchart illustrating an example process of determining the cause of an error in a method of operating a memory system.

FIGS. 8 and 9 are flowcharts illustrating an example method of operating a memory system;

FIGS. 10 and 11 are flowcharts illustrating an example process of detecting an error by a memory system.

FIG. 12A is a diagram illustrating data delivered to a memory device by a host.

FIG. 12B is a diagram illustrating Meta Data.

FIGS. 13 to 15 are diagrams illustrating an example three-dimensional V-NAND structure applicable to a memory device.

### DETAILED DESCRIPTION

Implementations will be described below with the attached drawings. Below, details such as detailed construction and structure are provided to help readers understand the implementations. Therefore, the implementations described herein may be changed or modified in various ways without departing from the implementations.

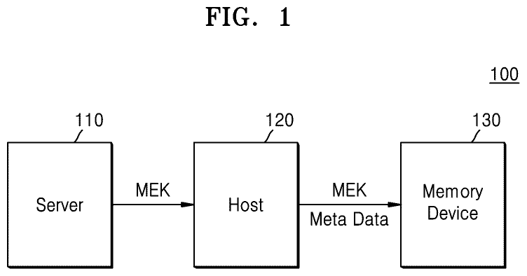

FIG. 1 is a block diagram of a memory system 100.

Referring to FIG. 1, the memory system 100 may include a server 110, a host 120, and a memory device 130.

The server 110 may deliver a user data encryption key MEK to the host 120. For example, the server 110 may manage the user data encryption key MEK. The server 110 may include a user data encryption key MEK management server. The server 110 may previously generate the user data encryption key MEK and deliver the generated user data encryption key MEK to the host 120 or deliver data including information on the user data encryption key MEK to the host 120, thereby allowing the host 120 to use the user data encryption key MEK. The user data encryption key MEK may encrypt user data of the memory device 130 so that the memory device 130 cannot know the user data. For example, when a user is a customer, the memory system 100 may prevent a manufacturer of the memory device 130 from knowing customer's data by using the user data encryption key MEK.

The host 120 may receive the user data encryption key MEK from the server 110. For example, the host 120 may receive the user data encryption key MEK managed by the server 110 or receive data including information on the user data encryption key MEK and use the user data encryption key MEK. The host 120 may generate the Meta Data about the user data encryption key MEK.

The Meta Data may include data about a user data encryption key MEK. For example, the Meta Data may include first data and second data including error information on the user data encryption key MEK. The first data may be for determining whether the host 120 has normally delivered the user data encryption key MEK to the memory device 130. The second data may be for determining whether the user data encryption key MEK received from the server 110 has been tampered with. By utilizing the Meta Data, the memory system 100 may determine the cause of occurrence of an error when the error has occurred in the user data encryption key MEK. For example, when an error has occurred in the first data, the memory system 100 may determine that the error has occurred in the memory device 130. Also, when an error has occurred in the second data, the memory system 100 may determine that the error has occurred in the server 110.

The first data may include a Host's NSID, a Host's Key Tag, a Host's UID, or user data encryption key index data MEK Index. The Host's NSID may be a unit of a set of a plurality of user data encryption keys MEK delivered by the host 120 to the memory device 130. The Host's Key Tag may include an identification tag of a single user data encryption key MEK delivered by the host 120 to the memory device 130. The Host's UID may include a unique identifier assigned to the host 120. The user data encryption key index data MEK Index may include data including delivery location information on the user data encryption key MEK.

The second data may include user data encryption key information eMEK or user data encryption key encryption information eKEK. The user data encryption key information eMEK may include information for allowing the host 120 to generate a user data encryption key MEK. The user data encryption key encryption information eKEK may include information for encrypting and delivering the user data encryption key MEK.

The user data encryption key MEK may include a media encryption key, the user data encryption key encryption information eKEK may include a key encryption key for the media encryption key, and the user data encryption key information eMEK may include a user data encryption key MEK as the user data encryption key encryption information eKEK. The user data encryption key information eMEK may include user data encryption key encryption information eKEK encrypted with a public key that is shared in a public key infrastructure environment between the server 110 and the memory device 130.

The host 120 may determine whether a user data encryption key MEK has been changed. For example, the host 120 may previously store the user data encryption key MEK and may determine whether the user data encryption key MEK has been changed by using Meta Data about the user data encryption key MEK. The host 120 may be configured to determine the cause of a change of the user data encryption key MEK, based on a result of comparison between information on previously stored Meta Data about the user data encryption key MEK and newly received Meta Data about the user data encryption key MEK, when it is determined that a user data encryption key MEK has been changed. For example, the host 120 may determine that the user data encryption key MEK has been changed due to an error occurring in any one of the server 110 or the memory device 130, based on the result of a comparison between the information in the stored Meta Data about the user data encryption key MEK and the received Meta Data about the user data encryption key MEK. When it is determined that the user data encryption key MEK has been changed, the host 120 may generate an error signal for the memory system 100.

The memory device 130 may receive a user data encryption key MEK and Meta Data about the user data encryption key MEK from the host 120 and may encrypt user data. The memory device 130 may include a non-volatile memory device. For example, the memory device 130 may include a solid-state drive (SSD) but is not limited thereto and may include a volatile memory or other types of non-volatile memory.

The memory device 130 may be configured to previously store Meta Data about a user data encryption key MEK and may encrypt or decrypt user data when received Meta Data about the user data encryption key MEK matches information on the stored Meta Data about the user data encryption key MEK. For example, the memory device 130 may set the user data encryption key MEK, and the memory device 130 may encrypt the user data when the user data encryption key MEK is set.

The memory device 130 may be configured to previously store Meta Data about a user data encryption key MEK and may perform input/output processing on data when received Meta Data about the user data encryption key MEK matches information on the stored Meta Data about the user data encryption key MEK. For example, the memory device 130 may set a user data encryption key MEK and may perform input/output processing on data when the user data encryption key MEK is set.

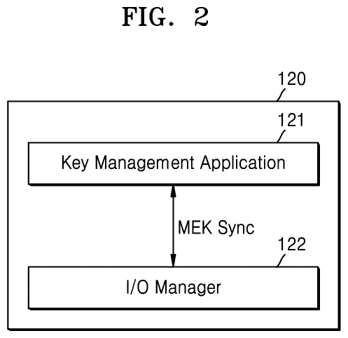

FIG. 2 is a block diagram of the host 120.

Referring to FIGS. 1 and 2, the host 120 may include a key management application 121 and a data input/output manager 122.

The key management application 121 may inject a user data encryption key MEK or Meta Data about the user data encryption key MEK into the memory device 130. The key management application 121 may be included in the host 120 as software or firmware. The key management application 121 may previously store a user data encryption key MEK and may compare the previously stored user data encryption key MEK with a user data encryption key MEK newly received by the data input/output manager 122. For example, the key management application 121 may exchange a user data encryption key synchronization signal MEK Sync with the data input/output manager 122. When the user data encryption key synchronization signal MEK Sync is input to the key management application 121 and the data input/output manager 122, the key management application 121 may deliver information on the stored user data encryption key MEK to the data input/output manager 122.

The data input/output manager 122 may compare information on virtual hosts (not shown) with information on a user data encryption key MEK. The virtual hosts (not shown) may include virtual machines (Tenant VMs).

The host 120 may determine whether the user data encryption key MEK has been tampered with, when performing a write operation on the memory device 130. Also, the host 120 may determine whether the user data encryption key MEK has been tampered with, when performing a data input/output processing operation on the memory device 130. For example, the host 120 may compare previously stored Meta Data about a user data encryption key MEK with Meta Data about the user data encryption key MEK received from virtual hosts (not shown) and may determine whether the user data encryption key MEK has been tampered with by the virtual hosts. The data input/output manager 122 may compare host name space information or host key tag information received from the virtual hosts (not shown) with the previously stored Meta Data about the user data encryption key MEK and may determine whether the user data encryption key MEK has been tampered with.

The host 120 may be configured to determine the cause of change of the user data encryption key MEK, based on a result of comparison between information on previously stored Meta Data about the user data encryption key MEK and newly received Meta Data about the user data encryption key MEK, when it is determined that a user data encryption key MEK has been changed. For example, the host 120 may determine that the user data encryption key MEK has been changed due to an error occurring in any one of the server 110 or the memory device 130, based on a result of comparison between first data or second data of the previously stored Meta Data and first data or second data of the newly received Meta Data.

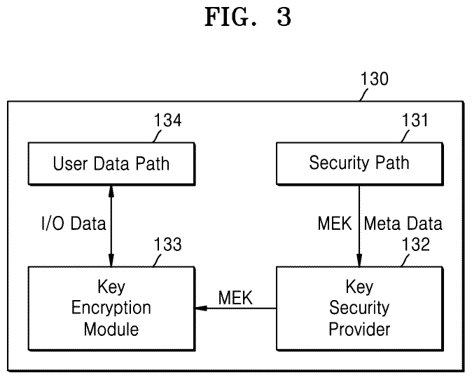

FIG. 3 is a block diagram of the memory device 130.

Referring to FIGS. 1 and 3, the memory device 130 may include a security path 131, a key security provider 132, a key encryption module 133, or a user data path 134.

The security path 131 may receive a user data encryption key MEK and Meta Data from the host 120. For example, the host 120 may receive the user data encryption key MEK and the Meta Data from the server 110 and may inject the user data encryption key MEK and the Meta Data into the memory device 130 through the security path 131.

The memory device 130 may be configured to previously store Meta Data about a user data encryption key MEK and may encrypt or decrypt user data when received Meta Data about the user data encryption key MEK matches information on the stored Meta Data about the user data encryption key MEK. For example, the key security provider 132 may deliver the user data encryption key MEK to the key encryption module 133, and the key encryption module 133 may set the user data encryption key MEK to the memory device 130. When the user data encryption key MEK is set, the memory device 130 is unable to know user data. The key encryption module 133 may encrypt the user data.

The user data path 134 may receive input/output data I/O Data delivered by the host 120. For example, the memory device 130 may set a user data encryption key MEK and may perform input/output processing on data when the user data encryption key MEK is set. When the user data encryption key MEK is set, the memory device 130 may perform a data input/output processing operation through the user data path 134. When the user data encryption key MEK is set, the memory device 130 may process data input/output processing signals received from virtual hosts (not shown) and may perform a data input/output operation.

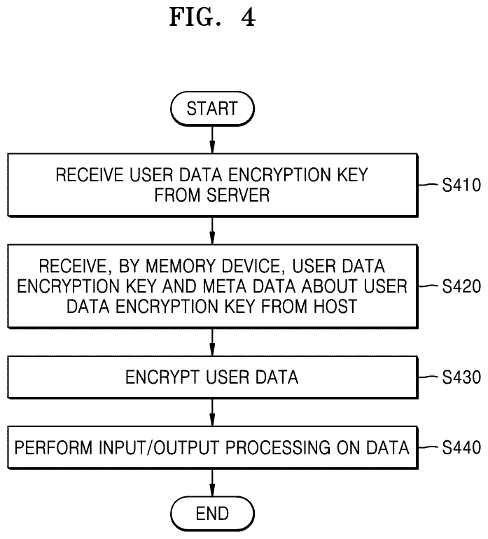

FIG. 4 is a flowchart illustrating a method of operating a memory system.

Referring to FIGS. 1 and 4, the host 120 of the memory system 100 may receive a user data encryption key MEK from the server 110 (S410).

The server 110 may manage a user data encryption key MEK. The server 110 may include a user data encryption key MEK management server. The server 110 may previously generate the user data encryption key MEK and deliver the generated user data encryption key MEK to the host 120 or deliver data including information on the user data encryption key MEK to the host 120, thereby allowing the host 120 to use the user data encryption key MEK. The user data encryption key MEK may encrypt user data of the memory device 130 so that the memory device 130 cannot know the user data. For example, when a user is a customer, the memory system 100 may prevent a manufacturer of the memory device 130 from knowing the customer's data by using the user data encryption key MEK.

When the host 120 receives the user data encryption key MEK, the memory device 130 of the memory system 100 may receive the user data encryption key MEK and Meta Data about the user data encryption key MEK from the host 120 (S420).

The host 120 may receive the user data encryption key MEK managed by the server 110 or receive data including information on the user data encryption key MEK and deliver the user data encryption key MEK to the memory device 130. The host 120 may generate Meta Data about the user data encryption key MEK and may deliver the generated Meta Data about the user data encryption key MEK to the memory device 130.

The Meta Data may include data about a user data encryption key MEK. For example, the Meta Data may include first data and second data including error information on the user data encryption key MEK. The first data may be for determining whether the host 120 has normally delivered the user data encryption key MEK to the memory device 130. The second data may be for determining whether the user data encryption key MEK received from the server 110 has been tampered with. By utilizing the Meta Data, the memory system 100 may determine the cause of occurrence of an error when the error has occurred in the user data encryption key MEK. For example, when an error has occurred in the first data, the memory system 100 may determine that the error has occurred in the memory device 130. Also, when an error has occurred in the second data, the memory system 100 may determine that the error has occurred in the server 110.

When the memory device 130 receives the user data encryption key MEK and the Meta Data about the user data encryption key MEK, the memory system 100 may encrypt user data (S430).

The memory system 100 may be configured to previously store Meta Data about a user data encryption key MEK and may encrypt or decrypt user data when the received Meta Data about the user data encryption key MEK matches information on the stored Meta Data about the user data encryption key MEK.

When the memory device 130 receives the user data encryption key MEK and the Meta Data about the user data encryption key MEK, the memory system 100 may perform an input/output processing operation on data (S440).

The memory system 100 may be configured to previously store Meta Data about a user data encryption key MEK and may perform input/output processing on data when received Meta Data about the user data encryption key MEK matches information of the stored Meta Data about the user data encryption key MEK.

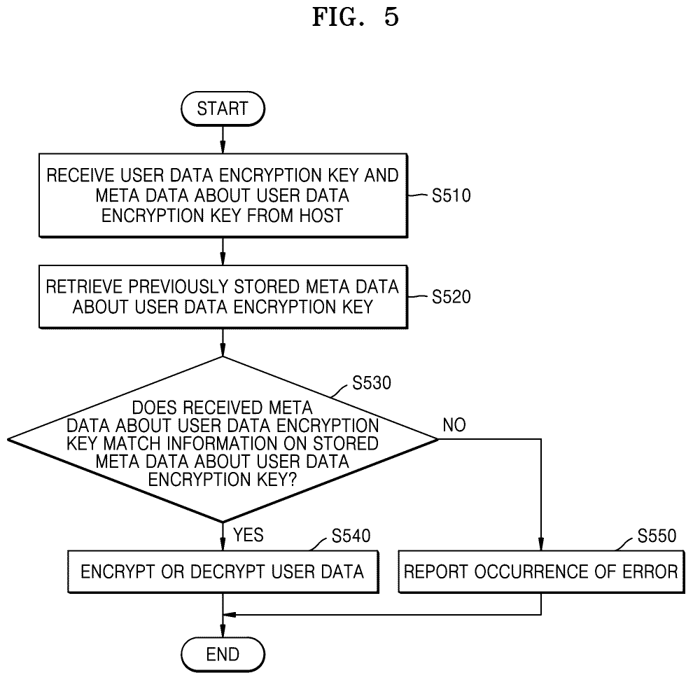

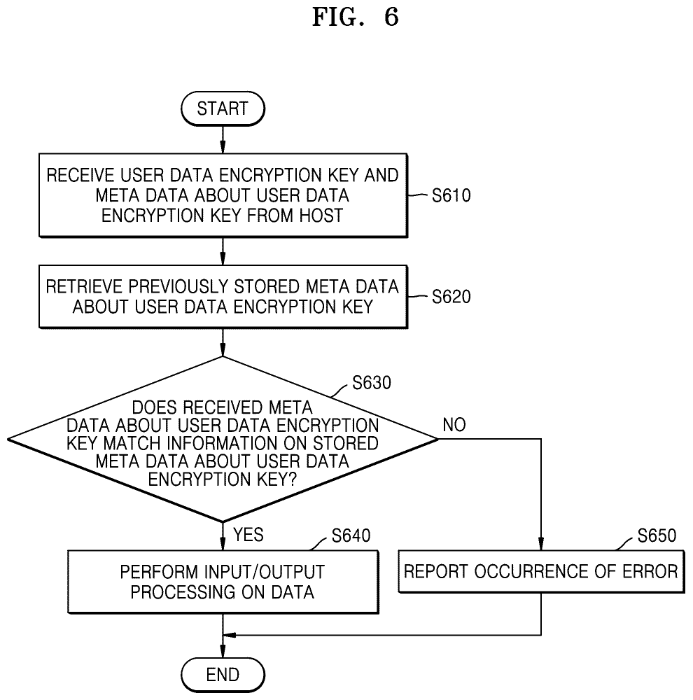

FIGS. 5 and 6 are flowcharts illustrating a process of detecting an error in a method of operating a memory system.

Referring to FIGS. 1 and 5, the memory system 100 may receive a user data encryption key MEK and Meta Data about the user data encryption key MEK from the host 120 (S510).

For example, the memory device 130 of the memory system 100 may receive a user data encryption key MEK and Meta Data about the user data encryption key MEK from the host 120.

In some implementations, the memory system 100 may previously store Meta Data about the user data encryption key MEK. In this case, upon receiving the user data encryption key MEK and the Meta Data about the user data encryption key MEK, the memory system 100 may retrieve such previously stored Meta Data about the user data encryption key MEK (S520).

For example, the memory system 100 may store Meta Data about the user data encryption key MEK when a write operation on the memory device 130 is first performed. When storing the Meta Data about the user data encryption key MEK previous to receiving new user data, the memory device 130 may not be able to recognize user data.

Therefore, when the Meta Data about the user data encryption key MEK is stored, the memory system 100 may determine whether the received Meta Data about the user data encryption key MEK matches information from the stored Meta Data about the user data encryption key MEK (S530).

The Meta Data may include data about a user data encryption key MEK. For example, the Meta Data may include first data and second data including error information of the user data encryption key MEK. The first data may be for determining whether the host 120 has normally delivered the user data encryption key MEK to the memory device 130. The second data may be for determining whether the user data encryption key MEK received from the server 110 has been tampered with. By utilizing the Meta Data, the memory system 100 may determine the cause of occurrence of an error when an error has occurred in the user data encryption key MEK. For example, when an error has occurred in the first data, the memory system 100 may determine that the error has occurred in the memory device 130. Also, when an error has occurred in the second data, the memory system 100 may determine that the error has occurred in the server 110.

The first data may include a Host's namespace ID (NSID), a Host's Key Tag, a Host's unique ID (UID), or user data encryption key index data MEK Index. The Host's NSID may be a unit of a set of a plurality of user data encryption keys MEK delivered by the host 120 to the memory device 130. The Host's Key Tag may include an identification tag of a single user data encryption key MEK delivered by the host 120 to the memory device 130. The Host's UID may include a unique identifier assigned to the host 120. The user data encryption key index data MEK Index may include data including delivery location information on the user data encryption key MEK.

The second data may include user data encryption key information eMEK or user data encryption key encryption information eKEK. The user data encryption key information eMEK may include information for allowing the host 120 to generate a user data encryption key MEK. The user data encryption key encryption information eKEK may include information for encrypting and delivering the user data encryption key MEK.

When it is determined that the received Meta Data about the user data encryption key MEK matches the information of the stored Meta Data about the user data encryption key MEK, the memory system 100 may encrypt or decrypt user data (S540).

However, when it is determined that the received Meta Data about the user data encryption key MEK does not match the information of the stored Meta Data about the user data encryption key MEK, the memory system 100 may report the occurrence of an error (S550). For example, the memory device 130 of the memory system 100 may report the occurrence of the error to the host 120.

Referring to FIGS. 1 and 6, the memory system 100 may receive a user data encryption key MEK and Meta Data about the user data encryption key MEK from the host 120 (S610).

For example, the memory device 130 of the memory system 100 may receive a user data encryption key MEK and Meta Data about the user data encryption key MEK from the host 120.

In some implementations, the memory system 100 may previously store Meta Data about the user data encryption key MEK. In this case, upon receiving the user data encryption key MEK and the Meta Data about the user data encryption key MEK, the memory system 100 may retrieve such previously stored Meta Data about the user data encryption key MEK (S620).

For example, the memory system 100 may store Meta Data about the user data encryption key MEK when a write operation on the memory device 130 is first performed. When storing the Meta Data about the user data encryption key MEK previous to receiving new user data, the memory device 130 may not be able to recognize user data.

Therefore, when the Meta Data about the user data encryption key MEK is stored, the memory system 100 may determine whether the received Meta Data about the user data encryption key MEK matches information from the stored user data about the user data encryption key MEK (S630). The Meta Data is the same as described in the implementation of FIG. 5.

When it is determined that the received Meta Data about the user data encryption key MEK matches the information from the stored Meta Data about the user data encryption key MEK, the memory system 100 may perform input/output processing on data (S640).

However, when it is determined that the received Meta Data about the user data encryption key MEK does not match the information from the previously stored Meta Data about the user data encryption key MEK, the memory system 100 may report the occurrence of an error (S650). For example, the memory device 130 of the memory system 100 may report the occurrence of the error to the host 120.

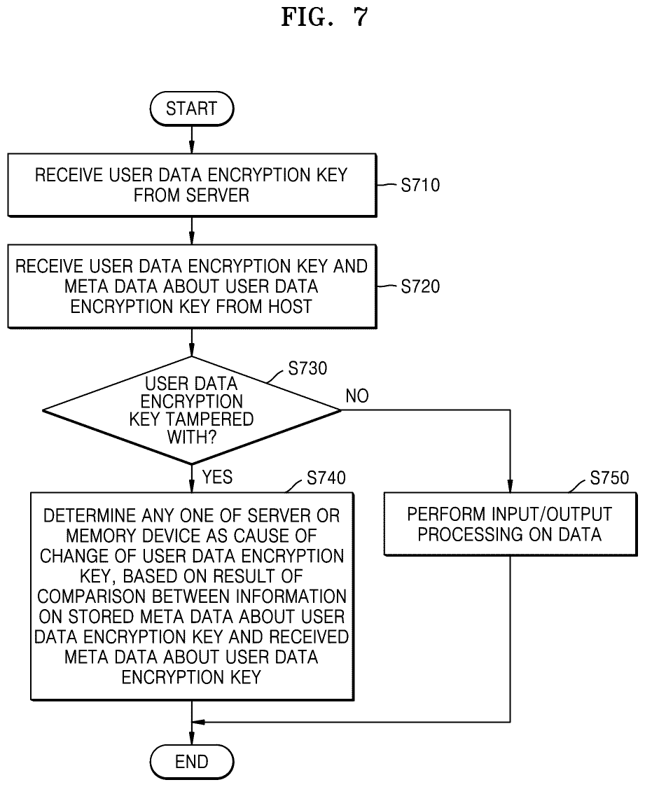

FIG. 7 is a flowchart illustrating a process of determining the cause of an error in a method of operating a memory system.

Referring to FIGS. 1 and 7, the memory system 100 may receive a user data encryption key MEK from the server 110 (S710).

For example, the host 120 may receive a user data encryption key MEK managed by the server 110 or receive data including information on the user data encryption key MEK and use the user data encryption key MEK. The host 120 may generate the Meta Data about the user data encryption key MEK.

When the host 120 receives the user data encryption key MEK, the memory device 130 of the memory system 100 may receive the user data encryption key MEK and the Meta Data about the user data encryption key MEK from the host 120 (S720).

The Meta Data may include data about a user data encryption key MEK. For example, the Meta Data may include first data and second data including error information associated with the user data encryption key MEK. The first data may be for determining whether the host 120 has normally delivered the user data encryption key MEK to the memory device 130. The second data may be for determining whether the user data encryption key MEK received from the server 110 has been tampered with.

When receiving the user data encryption key MEK and the Meta Data about the user data encryption key MEK, the memory system 100 may determine whether the user data encryption key MEK has been tampered with (S730). By utilizing the Meta Data, the memory system 100 may determine the cause of occurrence of an error when the error has occurred in the user data encryption key MEK.

The host 120 may determine whether the user data encryption key MEK has been tampered with, when performing a write operation on the memory device 130. Also, the host 120 may determine whether the user data encryption key MEK has been tampered with, when performing a data input/output processing operation on the memory device 130. For example, the host 120 may compare previously stored Meta Data about a user data encryption key MEK with Meta Data about the user data encryption key MEK received from virtual hosts (not shown) and may determine whether the user data encryption key MEK has been tampered with by the virtual hosts.

The data input/output manager 122 may compare host name space information or host key tag information received from the virtual hosts (not shown) with the previously stored Meta Data about the user data encryption key MEK and may determine whether the user data encryption key MEK has been tampered with.

When it is determined that the user data encryption key MEK has been tampered with, the memory system 100 may determine any one of the server 110 or the memory device 130 as the cause of change of the user data encryption key MEK, based on a result of comparison between information on the stored Meta Data about the user data encryption key MEK and the received Meta Data about the user data encryption key MEK (S740).

When an error has occurred in the first data, the memory system 100 may determine that the error has occurred in the memory device 130. Also, when an error has occurred in the second data, the memory system 100 may determine that the error has occurred in the server 110.

The first data may include a Host's NSID, a Host's Key Tag, a Host's UID, or user data encryption key index data MEK Index. The Host's NSID may be a unit of a set of a plurality of user data encryption keys MEK delivered by the host 120 to the memory device 130. The Host's Key Tag may include an identification tag of a single user data encryption key MEK delivered by the host 120 to the memory device 130. The Host's UID may include a unique identifier assigned to the host 120. The user data encryption key index data MEK Index may include data including delivery location information of the user data encryption key MEK.

The second data may include user data encryption key information eMEK or user data encryption key encryption information eKEK. The user data encryption key information eMEK may include information for allowing the host 120 to generate a user data encryption key MEK. The user data encryption key encryption information eKEK may include information for encrypting and delivering the user data encryption key MEK.

However, when it is determined that the user data encryption key MEK has not been tampered with, the memory system 100 may perform input/output processing on data (S750).

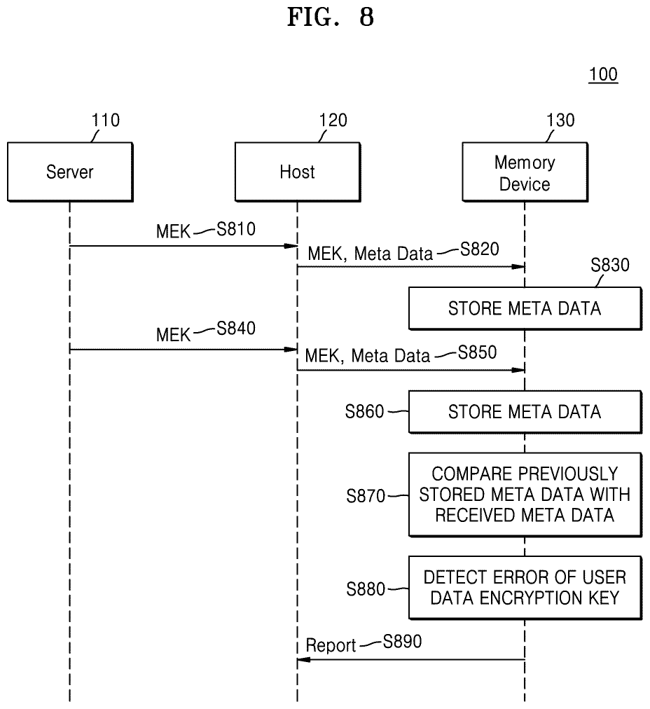

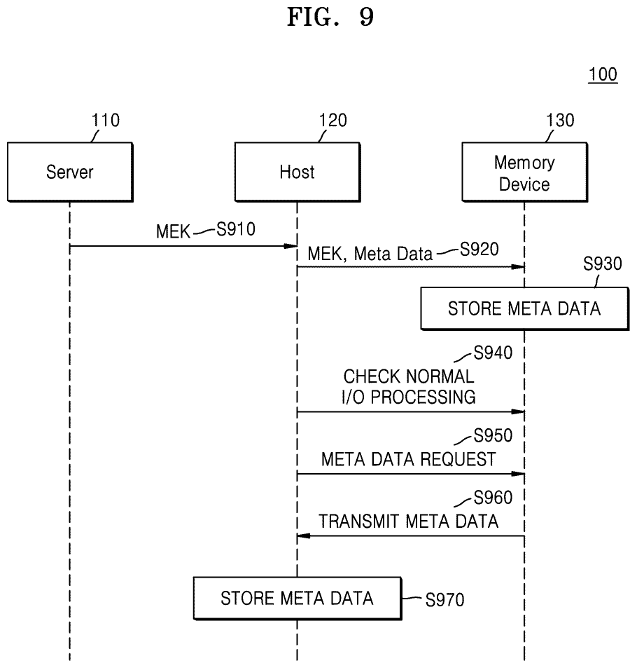

FIGS. 8 and 9 are flowcharts illustrating a method of operating the memory system 100.

FIG. 8 is a flowchart illustrating a process of detecting an error of a user data encryption key MEK by the memory system 100 according to an implementation.

Referring to FIGS. 1 and 8, the server 110 may deliver a user data encryption key MEK to the host 120 (S810).

The server 110 may deliver a user data encryption key MEK to the host 120. For example, the server 110 may manage the user data encryption key MEK. The server 110 may include a user data encryption key MEK management server. The server 110 may have previously generated the user data encryption key MEK and delivered the generated user data encryption key MEK to the host 120 or delivered data including information on the user data encryption key MEK to the host 120, thereby allowing the host 120 to use the user data encryption key MEK.

When the user data encryption key MEK is delivered to the host 120, the host 120 may deliver the user data encryption key MEK and Meta Data about the user data encryption key MEK to the memory device 130 (S820).

The host 120 may receive the user data encryption key MEK from the server 110. For example, the host 120 may receive the user data encryption key MEK managed by the server 110 or receive data including information on the user data encryption key MEK and use the user data encryption key MEK. The host 120 may generate the Meta Data about the user data encryption key MEK. The Meta Data may include data about a user data encryption key MEK. For example, the Meta Data may include first data and second data including error information on the user data encryption key MEK. The first data may be for determining whether the host 120 has normally delivered the user data encryption key MEK to the memory device 130. The second data may be for determining whether the user data encryption key MEK received from the server 110 has been tampered with.

Upon receiving the user data encryption key MEK and the Meta Data about the user data encryption key MEK, the memory device 130 may store the Meta Data (S830).

When the memory device 130 stores the Meta Data, the server 110 may again deliver a user data encryption key MEK to the host 120 (S840).

When the user data encryption key MEK is again delivered to the host 120, the host 120 may again deliver the user data encryption key MEK and Meta Data about the user data encryption key MEK to the memory device 130 (S850).

When the user data encryption key MEK and the Meta Data about the user data encryption key MEK are delivered again to the memory device 130, the memory system 100 may reconstruct the Meta Data (S860).

When the Meta Data is reconstructed, the memory system 100 may compare the Meta Data previously stored in S830 with the Meta Data received in S850 (S870).

By comparing the previously stored Meta Data with the received Meta Data, the memory system 100 may detect an error of the user data encryption key MEK (S880).

The Meta Data may include a Host's NSID, a Host's Key Tag, a Host's UID, user data encryption key index data MEK Index, user data encryption key information eMEK, or user data encryption key encryption information eKEK. By comparing respective pieces of information included in the Meta Data with each other, the memory system 100 may detect an error of the user data encryption key MEK.

When the error has occurred in the user data encryption key MEK, the memory device 130 may deliver an error report signal (Report) to the host 120 (S890).

FIG. 9 is a flowchart illustrating a process of storing Meta Data in the host 120 of the memory system 100, according to an implementation.

Referring to FIGS. 1 and 9, the server 110 may deliver a user data encryption key MEK to the host 120 (S910).

The server 110 may deliver a user data encryption key MEK to the host 120. For example, the server 110 may manage the user data encryption key MEK. The server 110 may include a user data encryption key MEK management server. The server 110 may have previously generated the user data encryption key MEK and delivered the generated user data encryption key MEK to the host 120 or delivered data including information on the user data encryption key MEK to the host 120, thereby allowing the host 120 to use the user data encryption key MEK.

When the user data encryption key MEK is delivered to the host 120, the host 120 may deliver the user data encryption key MEK and Meta Data about the user data encryption key MEK to the memory device 130 (S920).

The Meta Data may be the same as the Meta Data in the implementation of FIG. 8.

Upon receiving the user data encryption key MEK and the Meta Data about the user data encryption key MEK, the memory device 130 may store the Meta Data (S930).

When the Meta Data is stored in the memory device 130, the memory system 100 may check whether input/output (I/O) processing is normal (S940).

The memory device 130 may receive input/output data I/O Data delivered by the host 120. For example, the memory device 130 may set a user data encryption key MEK and may perform input/output processing on data when the user data encryption key MEK is set. When the user data encryption key MEK is set, the memory device 130 may perform a data input/output processing operation through the user data path 134. When the user data encryption key MEK is set, the memory device 130 may process data input/output processing signals received from virtual hosts (not shown) and may perform a data input/output operation.

When it is determined that the data input/output (I/O) processing operation is performed normally, the host 120 of the memory system 100 may send a Meta Data request to the memory device 130 (S950). The host 120 may determine whether the user data encryption key MEK has been tampered with, when performing the data input/output (I/O) processing operation on the memory device 130.

When receiving the Meta Data request from the host 120, the memory device 130 may deliver the Meta Data to the host 120 (S960).

When the Meta Data is delivered to the host 120, the host 120 may store the Meta Data (S970).

The host 120 may compare previously stored Meta Data about a user data encryption key MEK with Meta Data about the user data encryption key MEK received from virtual hosts (not shown) and may determine whether the user data encryption key MEK has been tampered with by the virtual hosts. The data input/output manager 122 may compare host name space information or host key tag information received from the virtual hosts (not shown) with the previously stored Meta Data about the user data encryption key MEK and may determine whether the user data encryption key MEK has been tampered with.

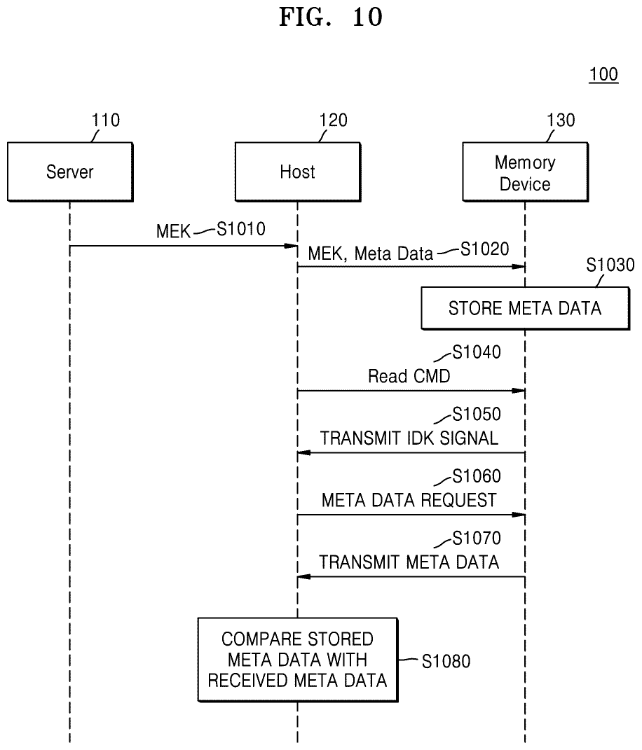

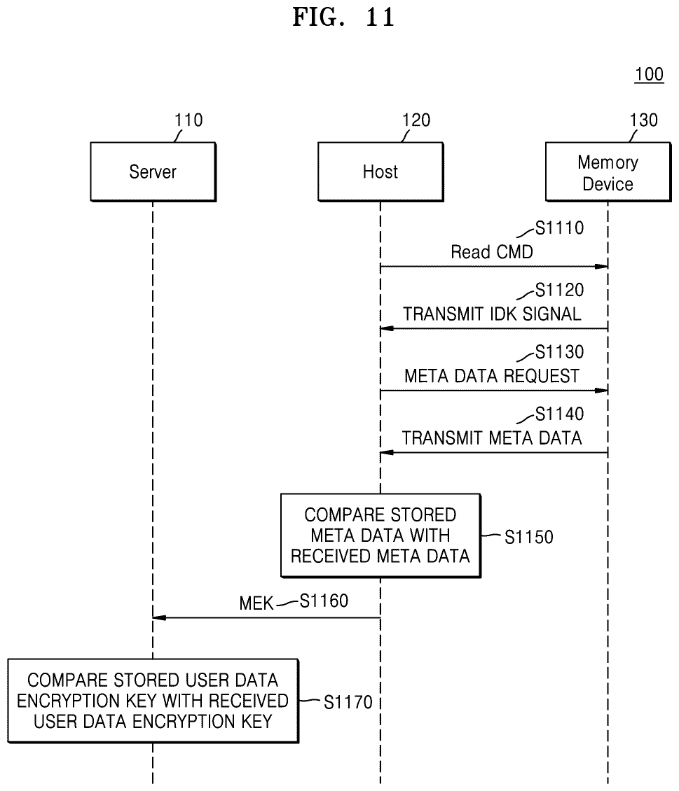

FIGS. 10 and 11 are flowcharts illustrating a process of detecting an error by a memory system.

FIG. 10 is a flowchart illustrating a process of determining whether an error has occurred in a user data encryption key MEK by the memory system 100, according to an implementation.

Referring to FIGS. 1 and 10, the server 110 may deliver a user data encryption key MEK to the host 120 (S1010).

The server 110 may deliver a user data encryption key MEK to the host 120. For example, the server 110 may manage the user data encryption key MEK. The server 110 may include a user data encryption key MEK management server. The server 110 may have previously generated the user data encryption key MEK and delivered the generated user data encryption key MEK to the host 120 or delivered data including information on the user data encryption key MEK to the host 120, thereby allowing the host 120 to use the user data encryption key MEK.

When the user data encryption key MEK is delivered to the host 120, the host 120 may deliver the user data encryption key MEK and Meta Data about the user data encryption key MEK to the memory device 130 (S1020).

The Meta Data is the same as the Meta Data in the implementations of FIGS. 8 and 9.

Upon receiving the user data encryption key MEK and the Meta Data about the user data encryption key MEK, the memory device 130 may store the Meta Data (S1030).

When the Meta Data is stored in the memory device 130, the host 120 of the memory system 100 may transmit a read command Read CMD to the memory device 130 (S1040). Upon receiving the read command Read CMD, the memory device 130 may perform a read operation and may determine whether the user data encryption key MEK has been tampered with, when performing the read operation.

When it is determined that the user data encryption key MEK has been tampered with, the memory device 130 may deliver an incorrect key detection (IDK) signal to the host 120 (S1050).

The memory system 100 may determine whether the user data encryption key MEK has been tampered with, when performing a write operation on the memory device 130. Also, the memory system 100 may determine whether the user data encryption key MEK has been tampered with, when performing a data input/output processing operation on the memory device 130. When it is determined that the user data encryption key MEK has been tampered with, the memory system 100 may generate an incorrect key detection (IDK) signal.

Upon receiving the incorrect key detection (IDK) signal, the host 120 may send a Meta Data request to the memory device 130 (S1060). The host 120 may determine whether the user data encryption key MEK has been tampered with, when performing a read operation on the memory device 130.

Upon receiving a Meta Data request signal, the memory device 130 may transmit the Meta Data to the host 120 (S1070).

Upon receiving the Meta Data, the host 120 may compare the stored Meta Data with the received Meta Data (S1080).

For example, the host 120 may compare previously stored Meta Data about a user data encryption key MEK with Meta Data about the user data encryption key MEK received from virtual hosts (not shown) and may determine whether the user data encryption key MEK has been tampered with by the virtual hosts. The data input/output manager 122 may compare host name space information or host key tag information received from the virtual hosts (not shown) with the previously stored Meta Data about the user data encryption key MEK and may determine whether the user data encryption key MEK has been tampered with.

FIG. 11 is a flowchart illustrating a process of determining the cause of an occurrence of an error in a method of operating the memory system 100 according to an implementation.

Referring to FIGS. 1 and 11, the host 120 of the memory system 100 may deliver a read command Read CMD to the memory device 130 (S1110).

Upon receiving the read command Read CMD, the memory device 130 may perform a read operation. When it is determined that a user data encryption key MEK has been tampered with when performing the read operation, the memory device 130 may deliver an incorrect key detection (IDK) signal to the host 120 (S1120).

The memory system 100 may determine whether the user data encryption key MEK has been tampered with, when performing a write operation on the memory device 130. Also, the memory system 100 may determine whether the user data encryption key MEK has been tampered with, when performing a data input/output processing operation on the memory device 130. When it is determined that the user data encryption key MEK has been tampered with, the memory system 100 may generate an incorrect key detection (IDK) signal.

Upon receiving the incorrect key detection (IDK) signal, the host 120 may send a Meta Data request to the memory device 130 (S1130). The host 120 may determine whether the user data encryption key MEK has been tampered with, when performing a read operation on the memory device 130.

Upon receiving a Meta Data request signal, the memory device 130 may transmit the Meta Data to the host 120 (S1140).

Upon receiving the Meta Data, the host 120 may compare previously stored Meta Data with the received Meta Data (S1150).

By comparing stored Meta Data with received Meta Data, the host 120 may determine the cause of an error occurring in the memory system 100. The Meta Data may include first data and second data including error information on a user data encryption key MEK. The first data may be for determining whether the host 120 has normally delivered the user data encryption key MEK to the memory device 130. The second data may be for determining whether the user data encryption key MEK received from the server 110 has been tampered with. By utilizing the Meta Data, the memory system 100 may determine the cause of occurrence of an error when the error has occurred in the user data encryption key MEK. For example, when an error has occurred in the first data, the memory system 100 may determine that the error has occurred in the memory device 130. Also, when an error has occurred in the second data, the memory system 100 may determine that the error has occurred in the server 110.

When it is determined that no error has occurred in the first data, the host 120 may deliver the user data encryption key MEK to the server 110 (S1160). Upon receiving the user data encryption key MEK, the server 110 may compare a stored user data encryption key MEK with the received user data encryption key MEK (S1170). By comparing components of the Meta Data with each other, the memory system 100 may determine whether an error has occurred in the user data encryption key MEK due to the abnormality of any one of the memory device 130 or the server 110.

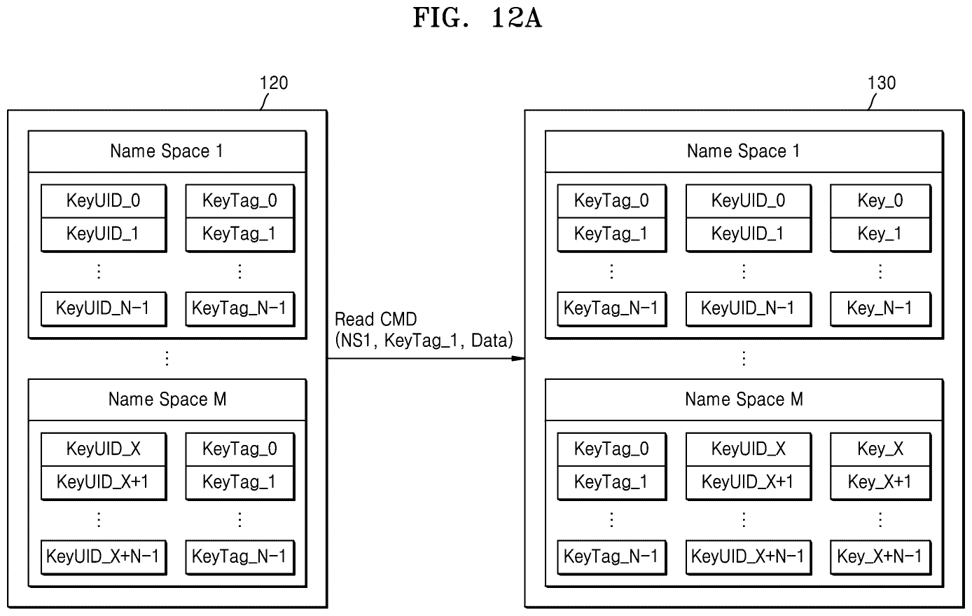

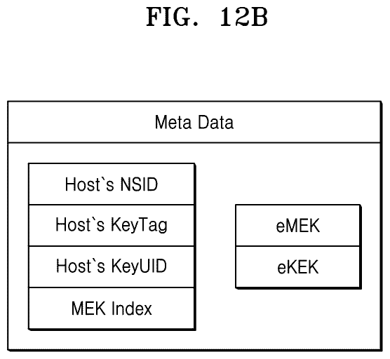

FIG. 12A is a diagram illustrating data delivered to a memory device by a host.

Referring to FIG. 12A, the host 120 may store data in a unit of name space. Each of name spaces may include a plurality of key unique identifiers KeyUID and a plurality of key tags KeyTag. For example, a first name space Name Space 1 may include a plurality of N key unique identifiers KeyUID_0 to KeyUID_N−1 and may include a plurality of N key tags KeyTag_0 to KeyTag_N−1. Also, an Mth name space Name Space M may include a plurality of N key unique identifiers KeyUID_X to KeyUID_X+N−1 and may include a plurality of N key tags KeyTag_0 to KeyTag_N−1.

The host 120 may store data included in the first name space Name Space 1 and may include first name space information NS1, first key tag information KeyTag_1, and arbitrary data Data in a read command Read CMD and may deliver the read command Read CMD to the memory device 130. The host 120 may include the first name space Name Space 1 to the Mth name space Name Space M. However, the number of name spaces that the host 120 may include is not limited to this and may include name spaces including a plurality of key unique identifiers KeyUID and a plurality of key tags KeyTag.

Upon receiving the read command Read CMD, the memory device 130 may compare a key stored in a name space corresponding to read command Read CMD information with information from a received key. For example, when the first name space information NS1, the first key tag information KeyTag_1, and the arbitrary data Data are included in the read command Read CMD, the memory device 130 may compare the first name space information NS1, first key tag information KeyTag_1, and arbitrary data Data included in the read command Read CMD with a first key tag information KeyTag_1, a first key unique identifier KeyUID_1, and a first key Key_1 of the first name space Name Space 1, and determine whether an error has occurred in a user data encryption key, based on whether the respective identification information pieces match each other. The identification information may include information included in each name space.

When the identification information pieces do not match each other, the memory device 130 may generate an incorrect key detection flag IDK Flag and report it to the host 120. For example, when it is determined that the first name space information NS1 and first key tag information KeyTag_1 included in the read command Read CMD do not match information on the first key tag information KeyTag_1, first key unique identifier KeyUID_1, and first key Key_1 of the first name space Name Space 1 of the memory device 130, the memory device 130 may generate an incorrect key detection flag IDK Flag for a corresponding user data encryption key, and report it to the host 120.

FIG. 12B is a diagram illustrating Meta Data.

The Meta Data may include data about a user data encryption key MEK. For example, the Meta Data may include first data and second data including error information on the user data encryption key MEK. The first data may be for determining whether the host 120 has normally delivered the user data encryption key MEK to the memory device 130. The second data may be for determining whether the user data encryption key MEK received from the server 110 has been tampered with. By utilizing the Meta Data, the memory system 100 may determine a cause of an occurrence of an error when the error has occurred in the user data encryption key MEK. For example, when an error has occurred in the first data, the memory system 100 may determine that the error has occurred in the memory device 130. Also, when an error has occurred in the second data, the memory system 100 may determine that the error has occurred in the server 110.

The first data may include a Host's NSID, a Host's Key Tag, a Host's UID, or user data encryption key index data MEK Index. The Host's NSID may be a unit of a set of a plurality of user data encryption keys MEK delivered by the host 120 to the memory device 130. The Host's Key Tag may include an identification tag of a single user data encryption key MEK delivered by the host 120 to the memory device 130. The Host's UID may include a unique identifier assigned to the host 120. The user data encryption key index data MEK Index may include data including delivery location information on the user data encryption key MEK.

The second data may include user data encryption key information eMEK or user data encryption key encryption information eKEK. The user data encryption key information eMEK may include information for allowing the host 120 to generate a user data encryption key MEK. The user data encryption key encryption information eKEK may include information for encrypting and delivering the user data encryption key MEK.

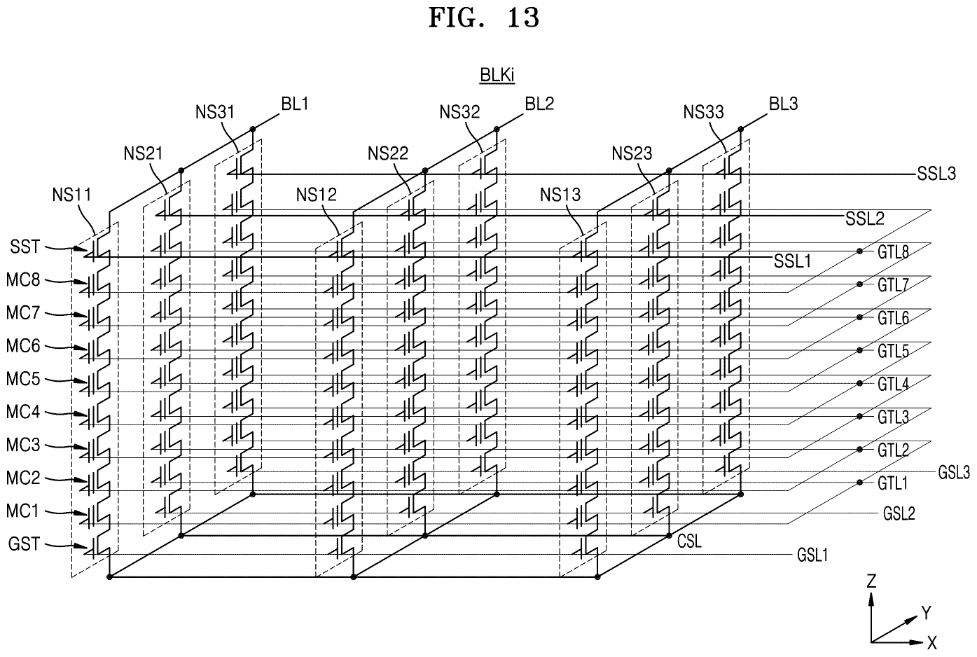

FIGS. 13 to 15 are diagrams illustrating a three-dimensional V-NAND structure applicable to a memory device.

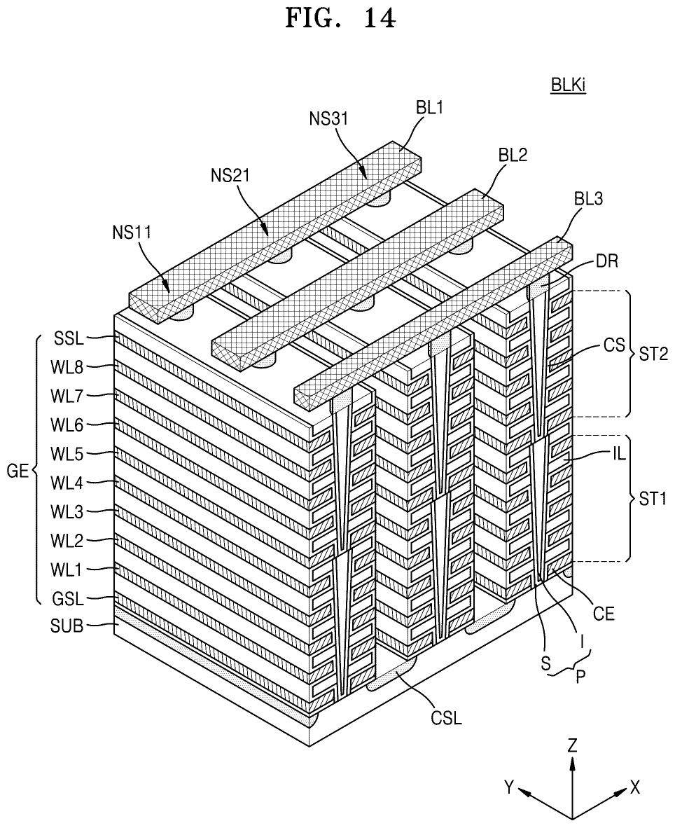

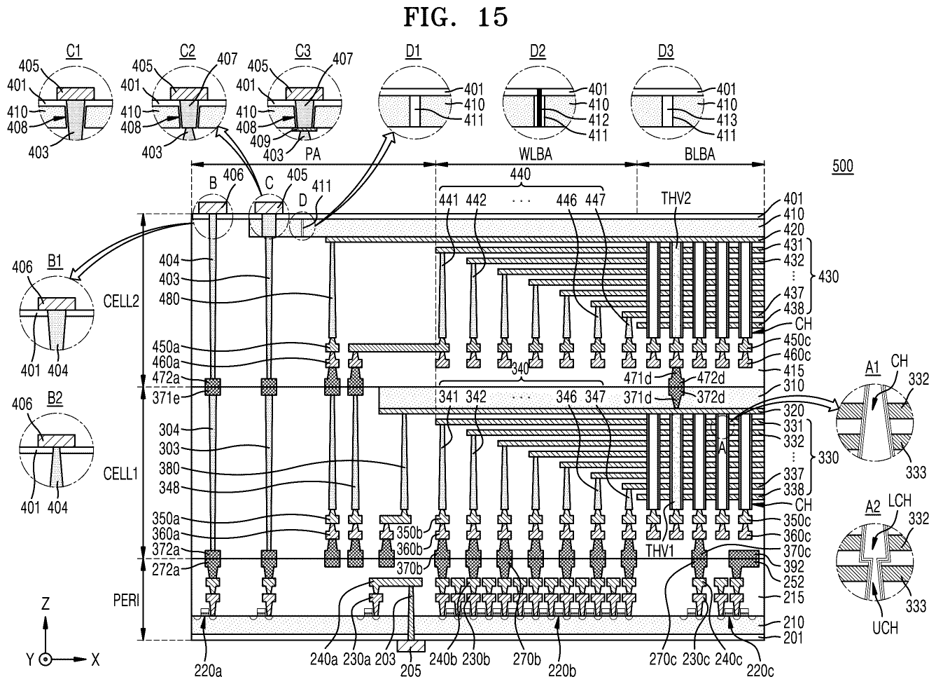

A memory applicable to the memory device (130 in FIG. 1) may include a plurality of memory blocks. FIGS. 13 and 14 illustrate the structure of one memory block BLKi among the plurality of memory blocks, and FIG. 15 illustrates an implementation example of the memory device (130 in FIG. 1).

Referring to FIG. 13, the memory block BLKi may include a plurality of memory NAND strings NS11 to NS33 that are connected between bit lines BL1, BL2, and BL3 and a common source line CSL. The plurality of memory NAND strings NS11 to NS33 may each include a string select transistor SST, a plurality of memory cells MC1 to MC8, and a ground select transistor GST. For brevity of the drawing, FIG. 13 shows that each of the plurality of memory NAND strings NS11 to NS33 includes eight memory cells MC1 to MC8 but implementations are not limited thereto.

The string select transistor SST may be connected to a corresponding string select line SSL1, SSL2 or SSL3. The plurality of memory cells MC1 to MC8 may be connected to corresponding gate lines GTL1 to GTL8, respectively. The gate lines GTL1 to GTL8 may correspond to word lines, and part of the gate lines GTL1 to GTL8 may correspond to dummy word lines. The ground select transistor GST may be connected to a corresponding ground select line GSL1, GSL2 or GSL3. The string select transistor SST may be connected to the corresponding bit line BL1, BL2 or BL3, and the ground select transistor GST may be connected to the common source line CSL.

The gate line (e.g., GTL1) of the same height may be connected in common, and the ground select lines GSL1, GSL2, and GSL3 may be separated from the string select lines SSL1, SSL2, and SSL3, respectively. In FIG. 13, it is illustrated that the memory block BLKi may be connected to eight gate lines GTL1 to GTL8 and three bit lines BL1, BL2, and BL3, but implementations are not necessarily limited thereto.

Referring further to FIG. 14, the memory block BLKi may be formed in a vertical direction with respect to a substrate SUB. The memory cells constituting memory NAND strings NS11 to NS33 may be formed by being stacked on a plurality of semiconductor layers.

The common source line CSL extending in a first direction (a Y direction) may be provided on the substrate SUB. A plurality of insulating films IL extending in the first direction (the Y direction) may be sequentially provided in a third direction (a Z direction) in a region of the substrate SUB between two adjacent common source lines CSL, and the plurality of insulating films IL may be spaced a specific distance apart in the third direction (the Z direction). A plurality of pillars P sequentially disposed in the first direction (the Y direction) and penetrating the plurality of insulating films IL in the third direction (the Z direction) may be provided in a region of the substrate SUB between two adjacent common source lines CSL. The plurality of pillars P may penetrate the plurality of insulating films IL and contact the substrate SUB. A surface layer S of each pillar P may include a silicon (Si) material doped with a first conductivity type and may function as a channel region.

An inner layer I of each pillar P may include an insulating material such as silicon oxide (SiO), or an air gap. A charge storage layer CS may be provided along an exposed surface of the insulating films IL, pillars P, and substrate SUB, in a region between two adjacent common source lines CSL. The charge storage layer CS may include a gate insulating layer (also referred to as a ‘tunneling insulating layer’), a charge trap layer, and a blocking insulating layer. Also, gate electrodes GE such as select lines GSL and SSL and word lines WL1 to WL8 may be provided on an exposed surface of the charge storage layer CS, in a region between two adjacent common source lines CSL. Drains or drain contacts DR may be provided on the plurality of pillars P, respectively. The bit lines BL1 to BL3 extending in a second direction (an X direction) and arranged to be spaced a specific distance apart in the first direction (the Y direction) may be provided on the drain contacts DR.

As shown in FIG. 13, each memory NAND string NS11 to NS33 may be implemented to have a structure in which a first memory stack ST1 and a second memory stack ST2 are stacked. The first memory stack ST1 may be connected to the common source line CSL, the second memory stack ST2 may be connected to the bit lines BL1 to BL3, and the first memory stack ST1 and the second memory stack ST2 may be stacked to share a channel hole with each other.

FIG. 15 is a view illustrating a memory device 500 according to some implementations.

Referring to FIG. 15, the memory device 500 may have a chip-to-chip (C2C) structure. At least one upper chip including a cell region and a lower chip including a peripheral circuit region PERI may be manufactured separately, and then, the at least one upper chip and the lower chip may be connected to each other by a bonding method to realize the C2C structure. For example, the bonding method may mean a method of electrically or physically connecting a bonding metal pattern formed in an uppermost metal layer of the upper chip to a bonding metal pattern formed in an uppermost metal layer of the lower chip. For example, in a case in which the bonding metal patterns are formed of copper (Cu), the bonding method may be a Cu—Cu bonding method. Alternatively, the bonding metal patterns may be formed of aluminum (Al) or tungsten (W).

The memory device 500 may include the at least one upper chip including the cell region. For example, as illustrated in FIG. 15, the memory device 500 may include two upper chips. However, the number of the upper chips is not limited thereto. In the case in which the memory device 500 includes the two upper chips, a first upper chip including a first cell region CELL1, a second upper chip including a second cell region CELL2 and the lower chip including the peripheral circuit region PERI may be manufactured separately, and then, the first upper chip, the second upper chip and the lower chip may be connected to each other by the bonding method to manufacture the memory device 500. The first upper chip may be turned over and then may be connected to the lower chip by the bonding method, and the second upper chip may also be turned over and then may be connected to the first upper chip by the bonding method. Hereinafter, upper and lower portions of each of the first and second upper chips will be defined based on before each of the first and second upper chips is turned over. In other words, an upper portion of the lower chip may mean an upper portion defined based on a +Z-axis direction, and the upper portion of each of the first and second upper chips may mean an upper portion defined based on a −Z-axis direction in FIG. 15. However, implementations are not limited thereto. In certain implementations, one of the first upper chip and the second upper chip may be turned over and then may be connected to a corresponding chip by the bonding method.

Each of the peripheral circuit region PERI and the first and second cell regions CELL1 and CELL2 of the memory device 500 may include an external pad bonding region PA, a word line bonding region WLBA, and a bit line bonding region BLBA.

The peripheral circuit region PERI may include a first substrate 210 and a plurality of circuit elements 220a, 220b and 220c formed on the first substrate 210. An interlayer insulating layer 215 including one or more insulating layers may be provided on the plurality of circuit elements 220a, 220b and 220c, and a plurality of metal lines electrically connected to the plurality of circuit elements 220a, 220b and 220c may be provided in the interlayer insulating layer 215. For example, the plurality of metal lines may include first metal lines 230a, 230b and 230c connected to the plurality of circuit elements 220a, 220b and 220c, and second metal lines 240a, 240b and 240c formed on the first metal lines 230a, 230b and 230c. The plurality of metal lines may be formed of at least one of various conductive materials. For example, the first metal lines 230a, 230b and 230c may be formed of tungsten having a relatively high electrical resistivity, and the second metal lines 240a, 240b and 240c may be formed of copper having a relatively low electrical resistivity.

The first metal lines 230a, 230b and 230c and the second metal lines 240a, 240b and 240c are illustrated and described in the present implementations. However, implementations are not limited thereto. In certain implementations, at least one or more additional metal lines may further be formed on the second metal lines 240a, 240b and 240c. In this case, the second metal lines 240a, 240b and 240c may be formed of aluminum, and at least some of the additional metal lines formed on the second metal lines 240a, 240b and 240c may be formed of copper having an electrical resistivity lower than that of aluminum of the second metal lines 240a, 240b and 240c.

The interlayer insulating layer 215 may be disposed on the first substrate 210 and may include an insulating material such as silicon oxide and/or silicon nitride.

Each of the first and second cell regions CELL1 and CELL2 may include at least one memory block. The first cell region CELL1 may include a second substrate 310 and a common source line 320. A plurality of word lines 330 (331 to 338) may be stacked on the second substrate 310 in a direction (i.e., the Z-axis direction) perpendicular to a top surface of the second substrate 310. String selection lines and a ground selection line may be disposed on and under the word lines 330, and the plurality of word lines 330 may be disposed between the string selection lines and the ground selection line. Likewise, the second cell region CELL2 may include a third substrate 410 and a common source line 420, and a plurality of word lines 430 (431 to 438) may be stacked on the third substrate 410 in a direction (i.e., the Z-axis direction) perpendicular to a top surface of the third substrate 410. Each of the second substrate 310 and the third substrate 410 may be formed of at least one of various materials and may be, for example, a silicon substrate, a silicon-germanium substrate, a germanium substrate, or a substrate having a single-crystalline epitaxial layer grown on a single-crystalline silicon substrate. A plurality of channel structures CH may be formed in each of the first and second cell regions CELL1 and CELL2.

In some implementations, as illustrated in a region ‘A1’, the channel structure CH may be provided in the bit line bonding region BLBA and may extend in the direction perpendicular to the top surface of the second substrate 310 to penetrate the word lines 330, the string selection lines, and the ground selection line. The channel structure CH may include a data storage layer, a channel layer, and a filling insulation layer. The channel layer may be electrically connected to a first metal line 350c and a second metal line 360c in the bit line bonding region BLBA. For example, the second metal line 360c may be a bit line and may be connected to the channel structure CH through the first metal line 350c. The bit line 360c may extend in a first direction (e.g., a Y-axis direction) parallel to the top surface of the second substrate 310.

In some implementations, as illustrated in a region ‘A2’, the channel structure CH may include a lower channel LCH and an upper channel UCH, which are connected to each other. For example, the channel structure CH may be formed by a process of forming the lower channel LCH and a process of forming the upper channel UCH. The lower channel LCH may extend in the direction perpendicular to the top surface of the second substrate 310 to penetrate the common source line 320 and lower word lines 331 and 332. The lower channel LCH may include a data storage layer, a channel layer, and a filling insulation layer and may be connected to the upper channel UCH. The upper channel UCH may penetrate upper word lines 333 to 338. The upper channel UCH may include a data storage layer, a channel layer, and a filling insulation layer, and the channel layer of the upper channel UCH may be electrically connected to the first metal line 350c and the second metal line 360c. As a length of a channel increases, due to characteristics of manufacturing processes, it may be difficult to form a channel having a substantially uniform width. The memory device 500 according to the present implementations may include a channel having improved width uniformity due to the lower channel LCH and the upper channel UCH which are formed by the processes performed sequentially.

In the case in which the channel structure CH includes the lower channel LCH and the upper channel UCH as illustrated in the region ‘A2’, a word line located near to a boundary between the lower channel LCH and the upper channel UCH may be a dummy word line. For example, the word lines 332 and 333 adjacent to the boundary between the lower channel LCH and the upper channel UCH may be the dummy word lines. In this case, data may not be stored in memory cells connected to the dummy word line. Alternatively, the number of pages corresponding to the memory cells connected to the dummy word line may be less than the number of pages corresponding to the memory cells connected to a general word line. A level of a voltage applied to the dummy word line may be different from a level of a voltage applied to the general word line, and thus it is possible to reduce an influence of a non-uniform channel width between the lower and upper channels LCH and UCH on an operation of the memory device.

Meanwhile, the number of the lower word lines 331 and 332 penetrated by the lower channel LCH is less than the number of the upper word lines 333 to 338 penetrated by the upper channel UCH in the region ‘A2’. However, implementations are not limited thereto. In certain implementations, the number of the lower word lines penetrated by the lower channel LCH may be equal to or more than the number of the upper word lines penetrated by the upper channel UCH. In addition, structural features and connection relation of the channel structure CH disposed in the second cell region CELL2 may be substantially the same as those of the channel structure CH disposed in the first cell region CELL1.

In the bit line bonding region BLBA, a first through-electrode THV1 may be provided in the first cell region CELL1, and a second through-electrode THV2 may be provided in the second cell region CELL2. As illustrated in FIG. 15, the first through-electrode THV1 may penetrate the common source line 320 and the plurality of word lines 330. In certain implementations, the first through-electrode THV1 may further penetrate the second substrate 310. The first through-electrode THV1 may include a conductive material. Alternatively, the first through-electrode THV1 may include a conductive material surrounded by an insulating material. The second through-electrode THV2 may have the same shape and structure as the first through-electrode THV1.

In some implementations, the first through-electrode THV1 and the second through-electrode THV2 may be electrically connected to each other through a first through-metal pattern 372d and a second through-metal pattern 472d. The first through-metal pattern 372d may be formed at a bottom end of the first upper chip including the first cell region CELL1, and the second through-metal pattern 472d may be formed at a top end of the second upper chip including the second cell region CELL2. The first through-electrode THV1 may be electrically connected to the first metal line 350c and the second metal line 360c. A lower via 371d may be formed between the first through-electrode THV1 and the first through-metal pattern 372d, and an upper via 471d may be formed between the second through-electrode THV2 and the second through-metal pattern 472d. The first through-metal pattern 372d and the second through-metal pattern 472d may be connected to each other by the bonding method.

In addition, in the bit line bonding region BLBA, an upper metal pattern 252 may be formed in an uppermost metal layer of the peripheral circuit region PERI, and an upper metal pattern 392 having the same shape as the upper metal pattern 252 may be formed in an uppermost metal layer of the first cell region CELL1. The upper metal pattern 392 of the first cell region CELL1 and the upper metal pattern 252 of the peripheral circuit region PERI may be electrically connected to each other by the bonding method. In the bit line bonding region BLBA, the bit line 360c may be electrically connected to a page buffer included in the peripheral circuit region PERI. For example, some of the circuit elements 220c of the peripheral circuit region PERI may constitute the page buffer, and the bit line 360c may be electrically connected to the circuit elements 220c constituting the page buffer through an upper bonding metal pattern 370c of the first cell region CELL1 and an upper bonding metal pattern 270c of the peripheral circuit region PERI.

Referring continuously to FIG. 15, in the word line bonding region WLBA, the word lines 330 of the first cell region CELL1 may extend in a second direction (e.g., an X-axis direction) parallel to the top surface of the second substrate 310 and may be connected to a plurality of cell contact plugs 340 (341 to 347). First metal lines 350b and second metal lines 360b may be sequentially connected onto the cell contact plugs 340 connected to the word lines 330. In the word line bonding region WLBA, the cell contact plugs 340 may be connected to the peripheral circuit region PERI through upper bonding metal patterns 370b of the first cell region CELL1 and upper bonding metal patterns 270b of the peripheral circuit region PERI.

The cell contact plugs 340 may be electrically connected to a row decoder included in the peripheral circuit region PERI. For example, some of the circuit elements 220b of the peripheral circuit region PERI may constitute the row decoder, and the cell contact plugs 340 may be electrically connected to the circuit elements 220b constituting the row decoder through the upper bonding metal patterns 370b of the first cell region CELL1 and the upper bonding metal patterns 270b of the peripheral circuit region PERI. In some implementations, an operating voltage of the circuit elements 220b constituting the row decoder may be different from an operating voltage of the circuit elements 220c constituting the page buffer. For example, the operating voltage of the circuit elements 220c constituting the page buffer may be greater than the operating voltage of the circuit elements 220b constituting the row decoder.

Likewise, in the word line bonding region WLBA, the word lines 430 of the second cell region CELL2 may extend in the second direction (e.g., the X-axis direction) parallel to the top surface of the third substrate 410 and may be connected to a plurality of cell contact plugs 440 (441 to 447). The cell contact plugs 440 may be connected to the peripheral circuit region PERI through an upper metal pattern of the second cell region CELL2 and lower and upper metal patterns and a cell contact plug 348 of the first cell region CELL1.

In the word line bonding region WLBA, the upper bonding metal patterns 370b may be formed in the first cell region CELL1, and the upper bonding metal patterns 270b may be formed in the peripheral circuit region PERI. The upper bonding metal patterns 370b of the first cell region CELL1 and the upper bonding metal patterns 270b of the peripheral circuit region PERI may be electrically connected to each other by the bonding method. The upper bonding metal patterns 370b and the upper bonding metal patterns 270b may be formed of aluminum, copper, or tungsten.

In the external pad bonding region PA, a lower metal pattern 371e may be formed in a lower portion of the first cell region CELL1, and an upper metal pattern 472a may be formed in an upper portion of the second cell region CELL2. The lower metal pattern 371e of the first cell region CELL1 and the upper metal pattern 472a of the second cell region CELL2 may be connected to each other by the bonding method in the external pad bonding region PA. Likewise, an upper metal pattern 372a may be formed in an upper portion of the first cell region CELL1, and an upper metal pattern 272a may be formed in an upper portion of the peripheral circuit region PERI. The upper metal pattern 372a of the first cell region CELL1 and the upper metal pattern 272a of the peripheral circuit region PERI may be connected to each other by the bonding method.

Common source line contact plugs 380 and 480 may be disposed in the external pad bonding region PA. The common source line contact plugs 380 and 480 may be formed of a conductive material such as a metal, a metal compound, and/or doped polysilicon. The common source line contact plug 380 of the first cell region CELL1 may be electrically connected to the common source line 320, and the common source line contact plug 480 of the second cell region CELL2 may be electrically connected to the common source line 420. A first metal line 350a and a second metal line 360a may be sequentially stacked on the common source line contact plug 380 of the first cell region CELL1, and a first metal line 450a and a second metal line 460a may be sequentially stacked on the common source line contact plug 480 of the second cell region CELL2.

Input/output pads 205, 405 and 406 may be disposed in the external pad bonding region PA. Referring to FIG. 15, a lower insulating layer 201 may cover a bottom surface of the first substrate 210, and a first input/output pad 205 may be formed on the lower insulating layer 201. The first input/output pad 205 may be connected to at least one of a plurality of the circuit elements 220a disposed in the peripheral circuit region PERI through a first input/output contact plug 203 and may be separated from the first substrate 210 by the lower insulating layer 201. In addition, a side insulating layer may be disposed between the first input/output contact plug 203 and the first substrate 210 to electrically isolate the first input/output contact plug 203 from the first substrate 210.

An upper insulating layer 401 covering a top surface of the third substrate 410 may be formed on the third substrate 410. A second input/output pad 405 and/or a third input/output pad 406 may be disposed on the upper insulating layer 401. The second input/output pad 405 may be connected to at least one of the plurality of circuit elements 220a disposed in the peripheral circuit region PERI through second input/output contact plugs 403 and 303, and the third input/output pad 406 may be connected to at least one of the plurality of circuit elements 220a disposed in the peripheral circuit region PERI through third input/output contact plugs 404 and 304.

In some implementations, the third substrate 410 may not be disposed in a region in which the input/output contact plug is disposed. For example, as illustrated in a region ‘B’, the third input/output contact plug 404 may be separated from the third substrate 410 in a direction parallel to the top surface of the third substrate 410 and may penetrate an interlayer insulating layer 415 of the second cell region CELL2 so as to be connected to the third input/output pad 406. In this case, the third input/output contact plug 404 may be formed by at least one of various processes.

In some implementations, as illustrated in a region ‘B1’, the third input/output contact plug 404 may extend in a third direction (e.g., the Z-axis direction), and a diameter of the third input/output contact plug 404 may become progressively greater toward the upper insulating layer 401. In other words, a diameter of the channel structure CH described in the region ‘A1’ may become progressively less toward the upper insulating layer 401, but the diameter of the third input/output contact plug 404 may become progressively greater toward the upper insulating layer 401. For example, the third input/output contact plug 404 may be formed after the second cell region CELL2 and the first cell region CELL1 are bonded to each other by the bonding method.

In certain implementations, as illustrated in a region ‘B2’, the third input/output contact plug 404 may extend in the third direction (e.g., the Z-axis direction), and a diameter of the third input/output contact plug 404 may become progressively less toward the upper insulating layer 401. In other words, like the channel structure CH, the diameter of the third input/output contact plug 404 may become progressively less toward the upper insulating layer 401. For example, the third input/output contact plug 404 may be formed together with the cell contact plugs 440 before the second cell region CELL2 and the first cell region CELL1 are bonded to each other.

In certain implementations, the input/output contact plug may overlap with the third substrate 410. For example, as illustrated in a region ‘C’, the second input/output contact plug 403 may penetrate the interlayer insulating layer 415 of the second cell region CELL2 in the third direction (e.g., the Z-axis direction) and may be electrically connected to the second input/output pad 405 through the third substrate 410. In this case, a connection structure of the second input/output contact plug 403 and the second input/output pad 405 may be realized by various methods.

In some implementations, as illustrated in a region ‘C1’, an opening 408 may be formed to penetrate the third substrate 410, and the second input/output contact plug 403 may be connected directly to the second input/output pad 405 through the opening 408 formed in the third substrate 410. In this case, as illustrated in the region ‘C1’, a diameter of the second input/output contact plug 403 may become progressively greater toward the second input/output pad 405. However, implementations are not limited thereto, and in certain implementations, the diameter of the second input/output contact plug 403 may become progressively less toward the second input/output pad 405.

In certain implementations, as illustrated in a region ‘C2’, the opening 408 penetrating the third substrate 410 may be formed, and a contact 407 may be formed in the opening 408. An end of the contact 407 may be connected to the second input/output pad 405, and another end of the contact 407 may be connected to the second input/output contact plug 403. Thus, the second input/output contact plug 403 may be electrically connected to the second input/output pad 405 through the contact 407 in the opening 408. In this case, as illustrated in the region ‘C2’, a diameter of the contact 407 may become progressively greater toward the second input/output pad 405, and a diameter of the second input/output contact plug 403 may become progressively less toward the second input/output pad 405. For example, the second input/output contact plug 403 may be formed together with the cell contact plugs 440 before the second cell region CELL2 and the first cell region CELL1 are bonded to each other, and the contact 407 may be formed after the second cell region CELL2 and the first cell region CELL1 are bonded to each other.

In certain implementations illustrated in a region ‘C3’, a stopper 409 may further be formed on a bottom end of the opening 408 of the third substrate 410, as compared with the implementations of the region ‘C2’. The stopper 409 may be a metal line formed in the same layer as the common source line 420. Alternatively, the stopper 409 may be a metal line formed in the same layer as at least one of the word lines 430. The second input/output contact plug 403 may be electrically connected to the second input/output pad 405 through the contact 407 and the stopper 409.

Like the second and third input/output contact plugs 403 and 404 of the second cell region CELL2, a diameter of each of the second and third input/output contact plugs 303 and 304 of the first cell region CELL1 may become progressively less toward the lower metal pattern 371e or may become progressively greater toward the lower metal pattern 371e.

Meanwhile, in some implementations, a slit 411 may be formed in the third substrate 410. For example, the slit 411 may be formed at a certain position of the external pad bonding region PA. For example, as illustrated in a region ‘D’, the slit 411 may be located between the second input/output pad 405 and the cell contact plugs 440 when viewed in a plan view. Alternatively, the second input/output pad 405 may be located between the slit 411 and the cell contact plugs 440 when viewed in a plan view.

In some implementations, as illustrated in a region ‘D1’, the slit 411 may be formed to penetrate the third substrate 410. For example, the slit 411 may be used to prevent the third substrate 410 from being finely cracked when the opening 408 is formed. However, implementations are not limited thereto, and in certain implementations, the slit 411 may be formed to have a depth ranging from about 60% to about 70% of a thickness of the third substrate 410.

In certain implementations, as illustrated in a region ‘D2’, a conductive material 412 may be formed in the slit 411. For example, the conductive material 412 may be used to discharge a leakage current occurring in driving of the circuit elements in the external pad bonding region PA to the outside. In this case, the conductive material 412 may be connected to an external ground line.

In certain implementations, as illustrated in a region ‘D3’, an insulating material 413 may be formed in the slit 411. For example, the insulating material 413 may be used to electrically isolate the second input/output pad 405 and the second input/output contact plug 403 disposed in the external pad bonding region PA from the word line bonding region WLBA. Since the insulating material 413 is formed in the slit 411, it is possible to prevent a voltage provided through the second input/output pad 405 from affecting a metal layer disposed on the third substrate 410 in the word line bonding region WLBA.

Meanwhile, in certain implementations, the first to third input/output pads 205, 405 and 406 may be selectively formed. For example, the memory device 500 may be realized to include only the first input/output pad 205 disposed on the first substrate 210, to include only the second input/output pad 405 disposed on the third substrate 410, or to include only the third input/output pad 406 disposed on the upper insulating layer 401.

In some implementations, at least one of the second substrate 310 of the first cell region CELL1 or the third substrate 410 of the second cell region CELL2 may be used as a sacrificial substrate and may be completely or partially removed before or after a bonding process. An additional layer may be stacked after the removal of the substrate. For example, the second substrate 310 of the first cell region CELL1 may be removed before or after the bonding process of the peripheral circuit region PERI and the first cell region CELL1, and then, an insulating layer covering a top surface of the common source line 320 or a conductive layer for connection may be formed. Likewise, the third substrate 410 of the second cell region CELL2 may be removed before or after the bonding process of the first cell region CELL1 and the second cell region CELL2, and then, the upper insulating layer 401 covering a top surface of the common source line 420 or a conductive layer for connection may be formed.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the embodiment has been particularly shown and described with reference to implementations thereof, it will be understood that various changes in form and details may be made therein without departing from the spirit and scope of the following claims.

What is claimed is:

1. A memory system operating with user data encryption, the memory system comprising:
a host configured to receive a user data encryption key from a server; and
a memory device configured to, from the host, receive the user data encryption key and meta data about the user data encryption key and configured to encrypt user data,
wherein the memory device is configured to
store the received meta data;
compare, based on a read operation being performed, the stored meta data about the user data encryption key with the received meta data about the user data encryption key to detect whether the user data encryption key has been changed; and
determine a cause of a change of the user data encryption key, based on a result of comparing the stored meta data about the user data encryption key with the received meta data about the user data encryption key.

2. The memory system of claim 1,
wherein the memory device is further configured to
store previously received meta data about the user data encryption key; and
encrypt or decrypt the user data based on the received meta data about the user data encryption key matching the stored meta data about the user data encryption key.

3. The memory system of claim 2,
wherein the memory device is further configured to perform input/output processing on data based on the received meta data about the user data encryption key matching the stored meta data about the user data encryption key.

4. The memory system of claim 1,
wherein the memory device is further configured to determine whether the user data encryption key has been changed, based on performing a write operation on the memory device.

5. The memory system of claim 1,
wherein the memory device is further configured to determine whether the user data encryption key has been changed, based on performing a data input/output processing operation on the memory device.

6. The memory system of claim 1,
wherein the host is further configured to determine at least one of the server or the memory device as the cause of the change of the user data encryption key, based on comparing the stored meta data about the user data encryption key with the received meta data about the user data encryption key.

7. The memory system of claim 1,
wherein the meta data comprises:
first data configured to determine whether the host has normally delivered the user data encryption key to the memory device; and
second data configured to determine whether the user data encryption key received from the server has been changed.

8. A method of operating a memory system operating with user data encryption, the method comprising:
receiving a user data encryption key from a server;
receiving, by a memory device, the user data encryption key and meta data about the user data encryption key from a host; and
encrypting user data,
wherein receiving the user data encryption key and the meta data about the user data encryption key from the host comprises:
storing the received meta data, and
detecting, based a read operation being performed, whether an error has occurred
in the user data encryption key by using the stored meta data, and
wherein, receiving the user data encryption key from the server comprises
determining that the user data encryption key has been changed and determining a cause of a change of the user data encryption key, based on a result of comparing the stored meta data about the user data encryption key with the received meta data about the user data encryption key.

9. The method of claim 8,
wherein receiving the user data encryption key and the meta data about the user data encryption key from the host comprises:
storing the previously received meta data about the user data encryption key; and
encrypting or decrypting the user data based on the received meta data about the user data encryption key matching the stored meta data about the user data encryption key.

10. The method of claim 9,
further comprising performing input/output processing on data based on the received meta data about the user data encryption key matching the stored meta data about the user data encryption key.

11. The method of claim 8,
wherein receiving the user data encryption key from the server comprises
determining whether the user data encryption key has been changed, based on performing a write operation on the memory device.

12. The method of claim 8,
wherein receiving the user data encryption key from the server comprises
determining whether the user data encryption key has been changed, based on performing a data input/output processing operation on the memory device.

13. The method of claim 8,
further comprising determining whether the user data encryption key has been changed, and
wherein the host is configured to
determine at least one of the server or the memory device as the cause of the change of the user data encryption key, based on comparing the stored meta data about the user data encryption key with the received meta data about the user data encryption key.

14. A memory system operating with user data encryption, the memory system comprising:
a server configured to manage a user data encryption key;
a host configured to receive the user data encryption key from the server; and
a memory device configured to receive the user data encryption key and meta data about the user data encryption key from the host and configured to encrypt user data,
wherein the memory device is configured to
store the received meta data;
compare, based on a read operation being performed, the stored meta data about the user data encryption key with the received meta data about the user data encryption key to detect whether the user data encryption key has been changed; and
determine a cause of a change of the user data encryption key, based on a result of comparing the stored meta data about the user data encryption key with the received meta data about the user data encryption key.

15. The memory system of claim 14,
wherein the memory device is configured to
store the previously received meta data about the user data encryption key; and
encrypt or decrypt the user data based on the received meta data about the user data encryption key matching the stored meta data about the user data encryption key.

16. The memory system of claim 15, wherein the memory device is further configured to
perform input/output processing on data based on the received meta data about the user data encryption key matching the stored meta data about the user data encryption key.

17. The memory system of claim 14,
determine whether the user data encryption key has been changed, based on performing a write operation on the memory device.

18. The memory system of claim 14,
determine whether the user data encryption key has been changed, based on performing a data input/output processing operation on the memory device.

19. The memory system of claim 14,
wherein the host is further configured to
determine at least one of the server or the memory device as the cause of the change of the user data encryption key, based on comparing the stored meta data about the user data encryption key with the received meta data about the user data encryption key.

20. The memory system of claim 14,
wherein the meta data comprises:
first data configured to determine whether the host has normally delivered the user data encryption key to the memory device; and
second data configured to determine whether the user data encryption key received from the server has been changed.
